(19) United States
(12) Patent Application Publication
(10) Pub. No.: US 2026/0003047 A1
(43) Pub. Date: Jan. 1, 2026

(54) SONAR TRANSDUCER ASSEMBLY AND SONAR

(71) Applicant: FURUNO ELECTRIC CO., LTD., Hyogo (JP)

(72) Inventor: Takeharu YAMAGUCHI, Akashi (JP)

(73) Assignee: FURUNO ELECTRIC CO., LTD., Hyogo (JP)

(21) Appl. No.: 19/050,399

(22) Filed: Feb. 11, 2025

(30) Foreign Application Priority Data
Jun. 26, 2024 (GB) 2409155.5

(51) Int. Cl. G01S 7/521

(52) U.S. Cl. CPC G01S 7/521

(57) ABSTRACT

A sonar transducer assembly including a housing and a plurality of transducer elements is disclosed. The housing has a cylindrical shape. The plurality of transducer elements is arranged in the housing. The plurality of transducer elements is arranged in a longitudinal direction of the housing so that, at any position of the longitudinal direction, a number of the transducer elements is no more than one. Each of the plurality of transducer elements extends in a radial direction of the housing and includes a transceiving face facing outward of the radial direction. Extension directions of adjacent transducer elements of the plurality of transducer elements are different from each other.

### CROSS-REFERENCE TO RELATED APPLICATION(S)

This application claims priority under 35 U.S.C. § 119 to United Kingdom Patent Application No. 2409155.5, which was filed on Jun. 26, 2024, the entire disclosure of which is hereby incorporated by reference.

### TECHNICAL FIELD

The present disclosure relates to a sonar transducer assembly and sonar.

### BACKGROUND

A conventional cylindrical sonar transducer assembly includes transducer elements that are arranged so as to form rings that are stacked in multiple layers.

The conventional sonar transducer assembly is difficult to miniaturize for the following reasons. If the diameter of the sonar transducer assembly is reduced, adjacent transducer elements may come into contact with each other. If the number of transducer elements is reduced to avoid contact, grating lobes may occur. If the length of the transducer elements is reduced to avoid contact, a desired resonance frequency may not be obtained.

### SUMMARY

A sonar transducer assembly according to a first aspect of the present disclosure includes a housing having a cylindrical shape; and a plurality of transducer elements arranged in the housing. The plurality of transducer elements is arranged in a longitudinal direction of the housing so that, at any position of the longitudinal direction, a number of the transducer elements is no more than one. Each of the plurality of transducer elements extends in a radial direction of the housing and includes a transceiving face facing outward of the radial direction. Extension directions of adjacent transducer elements of the plurality of transducer elements are different from each other. Thus, it is possible to realize miniaturization of the sonar transducer assembly.

In the above embodiment, the plurality of transducer elements may be arranged so that the transceiving faces of the plurality of transducer elements are positioned on a helix curve. Thus, it is possible to transmit and/or receive ultrasonic waves around the entire circumference. The plurality of transducer elements may be configured to transmit and/or receive ultrasonic wave having a given wavelength. The pitch of the helix curve may be less than or equal to half of the wavelength. Thus, it is possible to suppress the generation of grating lobes in the longitudinal direction.

A sonar according to a second aspect of the present disclosure includes the sonar transducer assembly according to the first aspect and circuitry connected to the sonar transducer assembly. Thus, it is possible to realize a sonar having a miniaturized sonar transducer assembly.

### BRIEF DESCRIPTION OF THE DRAWINGS

FIG. 1 is a view showing an exemplary configuration of a sonar.

FIG. 2 is a plan view showing an exemplary configuration of a sonar transducer assembly.

FIG. 3 is a side view showing an exemplary configuration of the sonar transducer assembly.

FIG. 4 is a perspective view showing an exemplary configuration of a transducer element.

FIG. 5 is a plan view showing a modification of the sonar transducer assembly.

### DETAILED DESCRIPTION

Embodiments of the present disclosure will now be described with reference to the drawings. In the present specification and drawings, an element like a previously described element with respect to a previous drawing may be denoted by the same reference numeral and a detailed description may be omitted accordingly.

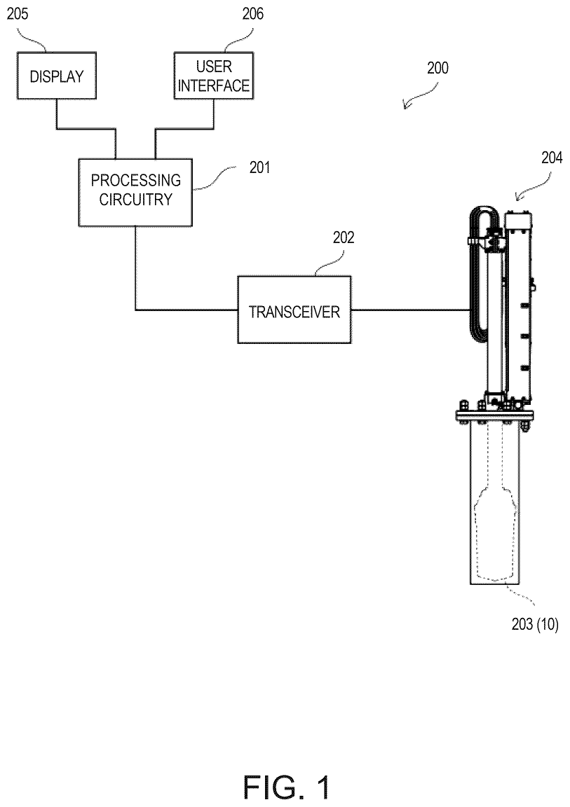

FIG. 1 is a diagram showing a configuration example of a sonar 200. The sonar 200 includes a control unit 201 (which may also be referred to as processing circuitry 201), a transceiver 202 (which may also be referred to as circuitry 202), a transmit/receive unit 203, an up-and-down unit 204, a display 205, and a user interface 206.

The control unit 201 may be a computer including a CPU, a RAM, a ROM, a nonvolatile memory, an input/output interface, and the like.

The transceiver 202 includes transmission circuitry and reception circuitry. The transmission circuitry generates a transmission signal and outputs it to the transmit/receive unit 203. The reception circuitry amplifies and A/D-converts an echo signal from the transmit/receive unit 203 and outputs it to the control unit 201.

The transmit/receive unit 203 includes a sonar transducer assembly 10 described later, emits ultrasonic waves into water based on the transmission signal from the transceiver 202 and outputs the echo signal based on a reflected wave to the transceiver 202.

The up-and-down unit 204 moves the transmit/receive unit 203 up and down. The up-and-down unit 204 projects the transmit/receive unit 203 downward from the bottom of a ship on which the sonar 200 is installed when the sonar 200 is in use, and stores the transmit/receive unit 203 above the bottom of the ship when the sonar 200 is not in use.

The sonar 200 may be a scanning sonar for detecting an object in the water by simultaneously emitting ultrasonic waves from the transmit/receive unit 203 in one or all directions.

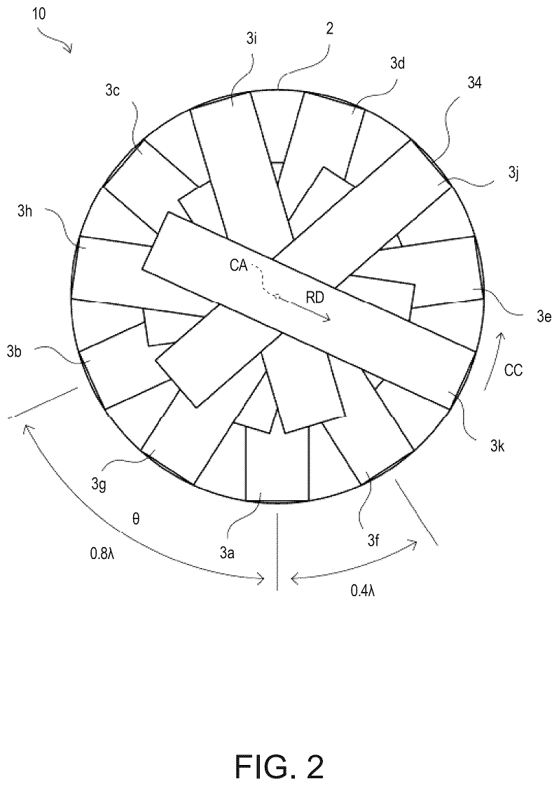

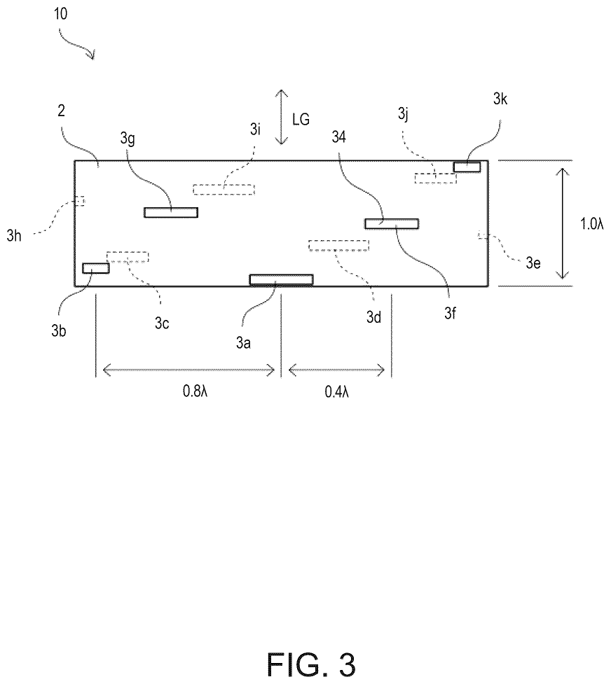

FIGS. 2 and 3 are a plan view and a side view showing a configuration example of the sonar transducer assembly 10. In these views, a configuration example of the sonar transducer assembly 10 is schematically shown, and illustration of wiring and the like is omitted.

The sonar transducer assembly 10 includes a cylindrical housing 2 and a plurality of transducer elements 3a to 3k contained in the housing 2. Hereinafter, the transducer elements 3a to 3k will also be collectively referred to simply as “transducer element 3”.

Point CA in FIGS. 2 and 3 represents the central axis of the housing 2, arrow RD represents a radial direction of the housing 2, arrow CC represents the circumferential direction of the housing 2, and arrow LG represents the longitudinal direction (also referred to as the axial direction) of the housing 2.

In FIGS. 2 and 3, only one set of transducer elements 3a to 3k is shown for illustrative purposes, but it is not limited thereto, and a plurality of sets of transducer elements 3a to 3k may be stacked in the longitudinal direction LG.

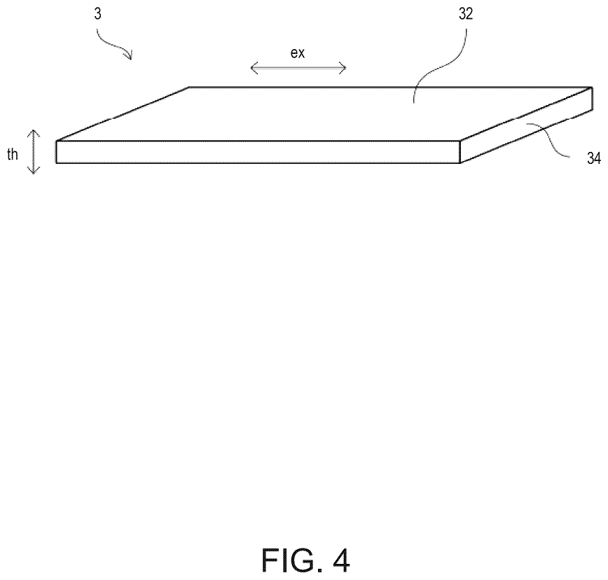

FIG. 4 is a perspective view showing an example of a structure of the transducer element 3. In FIG. 4, arrow “ex” represents an extension direction of the transducer element 3, and arrow “th” represents a thickness direction of the transducer element 3.

As shown in FIG. 4, the transducer element 3 is formed in a thin rectangular cuboid shape that is relatively long in the extension direction ex and relatively thin in the thickness direction th. The transducer element 3 is formed of a piezoelectric element. One end surface of the transducer element 3 in the extension direction ex is used as a transceiving face 34 for transmitting and/or receiving ultrasonic waves.

The transducer element 3 is configured to transmit and/or receive ultrasonic waves of a predetermined wavelength. The length of the extension direction ex of the transducer element 3 is set so as to obtain a desired resonance frequency. Although the transducer element 3 is thinner than a conventional element, since the thickness is independent of the design of the resonance frequency, there are no design problems.

A pair of main surfaces 32 perpendicular to the thickness direction th of the transducer element 3 is used as connection surfaces to which wirings (not shown) are connected. By making the transducer element 3 thin, impedance can be reduced, and the transducer element 3 can be driven with a relatively low voltage.

As shown in FIGS. 2 and 3, the transducer element 3 extends in the radial direction RD of the housing 2 and is accommodated in the housing 2 such that the transceiving face 34 faces outside the radial direction RD. That is, the transducer element 3 is arranged such that the extending direction ex coincides with the radial direction RD of the housing 2.

The transceiving face 34 of the transducer element 3 is coupled to a side wall of the housing 2. Specifically, the transceiving face 34 of the transducer element 3 and the side wall of the housing 2 are directly contacted or bonded through a hard resin such as a urethane adhesive so that an air layer is not interposed therebetween.

Thus, the transducer element 3 can transmit and/or receive ultrasonic waves in the radial direction RD through the side wall of the housing 2. On the other hand, the end face of the transducer element 3 opposite to the transceiving face 34 is separated from the side wall of the housing 2 and an air layer is interposed therebetween.

As shown in FIGS. 2 and 3, the plurality of transducer elements 3 is arranged in the longitudinal direction LG in the housing 2 so as to be stacked in the longitudinal direction LG. However, there is a small gap between adjacent transducer elements 3 and they are not in contact with each other.

In other words, the transducer elements 3 are arranged in the longitudinal direction LG such that a number of transducer elements 3 is no more than one at any position in the longitudinal direction LG of the housing 2.

That is, at a position where the transducer element 3 is present, the number of transducer elements 3 is one, and at a position between adjacent transducer elements 3, the number of transducer elements 3 is zero.

A length of the transducer elements 3 in the radial direction RD may be longer than the radius of the housing 2. Therefore, all the transducer elements 3 may be arranged on the central axis CA of the housing 2.

The transducer elements 3a to 3k are arranged in alphabetical order (in that order: 3a, 3b, 3c, . . . , 3k). When a plurality of sets of transducer elements 3a to 3k are stacked, the transducer element 3a is arranged next to the transducer element 3k. When a plurality of sets of transducer elements 3a to 3k are stacked, the extension directions of the elements 3a to 3k of a first set of the plurality of sets are the same as the extension directions of the elements 3a to 3k of a second set of the plurality of sets. I.e., the extension direction of, for example, element 3a of the first set is the same as the extension direction of the element 3a of the second set.

As shown in FIGS. 2 and 3, the extending directions of adjacent transducer elements 3 of the plurality of transducer elements 3 are different from each other. That is, directions of the transceiving faces 34 of the adjacent transducer elements 3 are different from each other.

In other words, the plurality of transducer elements 3 are rotated about the central axis CA by an angle different from zero. More specifically, the plurality of transducer elements 3 may be arranged such that the transceiving faces 34 are positioned on a helix curve.

In this embodiment, the transceiving faces 34 of the N transducer elements 3a to 3k (N is an odd number, e.g. 11) form a two-turn helix curve, and an angle θ formed by the extending directions of the adjacent transducer elements 3 is 720/N degrees.

Thus, the transceiving faces 34 of upper transducer elements 3g to 3k can be arranged with a half pitch shift in the circumferential direction CC with respect to the transceiving faces 34 of lower transducer elements 3a to 3f.

That is, as shown in FIG. 2, the transceiving faces 34 of the upper transducer elements 3g to 3k can be arranged between the transceiving faces 34 of the lower transducer elements 3a to 3f in plan view.

An arrangement pitch of the transceiving faces 34 of the transducer elements 3a to 3k will be described. In FIG. 3, the transceiving faces 34 appear to be sparsely present, but the arrangement pitch of the transceiving faces 34 is made equal to that of a conventional scanning sonar, and the generation of grating lobes is suppressed.

In the longitudinal direction LG, the pitch (i.e., the pitch of the helix curve for one turn) of the helix curve is preferably 0.5λ or less, and the pitch of the helix curve for two turns is preferably 1.0λ or less. λ is the wavelength of the ultrasonic wave transmitted and/or received by the transducer element 3.

The pitch of the helix curve for one turn is a distance in the longitudinal direction LG from the center of the transceiving face 34 of the first transducer element 3a to the middle of the transceiving face 34 of the sixth transducer element 3f and the transceiving face 34 of the seventh transducer element 3g.

The pitch in the longitudinal direction LG between two closest transceiving faces 34 of the transceiving faces 34 of the transducer elements 3a to 3k is preferably 0.5λ or less. The closest two transceiving faces 34 are, for example, the transceiving faces 34 of the first and sixth transducer elements 3a and 3f.

The pitch of the helix curve for two turns is a distance in the longitudinal direction LG including all of the transceiving faces 34 of one set of transducer elements 3a to 3k, or a distance in the longitudinal direction LG from the center of the transceiving face 34 of the first transducer element 3a to the center of the transceiving face 34 of the first transducer element 3a of the adjacent set.

When the number of transducer elements 3 included in the helix curve for two turns is N, the pitch in the longitudinal direction LG of the adjacent transducer elements 3 is set to λ/N or less. Thus, the pitch of the helix curve for one turn is 0.5λ or less, and the pitch of the helix curve for two turns is 1.0λ or less.

In the circumferential direction CC, the pitch along the circumferential direction CC of the transceiving faces 34 of the adjacent transducer elements 3 is preferably 0.8λ or less. In this case, the pitch in the circumferential direction CC between the transceiving faces 34 of the lower transducer elements 3a to 3f and the transceiving faces 34 of the upper transducer elements 3g to 3k is 0.4λ or less.

The pitch in the circumferential direction CC between two closest transceiving faces 34 of the transceiving faces 34 of the transducer elements 3a to 3k is preferably 0.4λ or less. The two closest transceiving faces 34 are, for example, the transceiving faces 34 of the first and sixth transducer elements 3a and 3f.

In one embodiment, a plurality of sets of transducer elements 3a to 3k is stacked in the longitudinal direction LG. The transducer elements 3a to 3k of each set are arranged in alphabetical order (in that order: 3a, 3b, 3c, . . . , 3k), as illustrated in FIGS. 2, 3. The plurality of transducer elements of the plurality of sets is arranged so that the transceiving faces of the plurality of transducer elements are positioned on a helix curve, and the helix curve comprises at least two turns. A first transducer element (e.g., element 3a of a first set of the plurality of sets), one or more second transducer elements (e.g., elements 3b to 3k of the first set), and a third transducer element (e.g., element 3a of a second set stacked on the first set) of the plurality of transducer elements are arranged so that the one or more second transducer elements (3b to 3k of the first set) are arranged between the first transducer element (3a of the first set) and the third transducer element (3a of the second set) in the longitudinal direction; the one or more second transducer elements (3b to 3k of the first set) comprise an even number of transducer elements; the transceiving face of the third transducer element (3a of the second set) is positioned on the helix curve so as to be separated from the transceiving face of the first transducer element (3a of the first set) by two turns; and the extension direction of the first transducer element (3a of the first set) is the same as the extension direction of the third transducer element (3a of the second set).

In one embodiment, the transducer elements 3a to 3k are arranged in alphabetical order (in that order: 3a, 3b, 3c, . . . , 3k), as illustrated in FIGS. 2, 3. The plurality of transducer elements 3a to 3k is arranged so that the transceiving faces of the plurality of transducer elements 3a to 3k are positioned on a helix curve, and the helix curve comprises at least two turns. A first transducer element (e.g., element 3a), a second transducer element (e.g., element 3f) and a third transducer element (e.g., element 3g) of the plurality of transducer elements 3a to 3k are arranged so that the second transducer element 3f and the third transducer element 3g are adjacent in the longitudinal direction LG; the transceiving face of the second transducer element 3f is positioned on the helix curve so as to be separated from the transceiving face of the first transducer element 3a by less than one turn; the transceiving face of the third transducer element 3g is positioned on the helix curve so as to be separated from the transceiving face of the first transducer element 3a by more than one turn; and the extension direction of the first transducer element 3a is in the middle between the extension directions of the second transducer element 3f and the third transducer element 3g.

According to the above-described embodiments, when the sonar transducer assembly 10 is miniaturized, the contact of the transducer elements 3 can be prevented, the generation of grating lobes can be suppressed, and the desired resonance frequency can be obtained.

That is, by arranging the transducer elements 3 as described above, even if the diameter of the housing 2 is reduced, contact between the transducer elements 3 can be prevented. In addition, the generation of grating lobes can be suppressed by suppressing an increase in the pitch of the transceiving faces 34. Further, the desired resonance frequency can be obtained by securing the length of the transducer elements 3. Furthermore, since the number of transducer elements 3 and transmission/reception circuitry connected thereto is reduced, cost can be reduced.

In one embodiment, the width (in circumferential direction CC) of the transducer elements 3 is 10 mm, the thickness (in longitudinal direction LG) is 1.0 mm, the length (in radial direction RD) is 18 mm, and the resonance frequency is 83.5 kHz. In the case of 83.5 kHz, the wavelength λ is 18.0 mm (assuming an ultrasound speed of 1500 m/s).

If the transducer elements 3 having the thickness of 1.0 mm are arranged with a gap of approximately 0.4 mm in the longitudinal direction LG, thirteen transducer elements 3 can be arranged in two turns within 1.02 (6.5 transducer elements 3 in one turn within 0.52).

In the case of thirteen transducer elements 3, the diameter of the sonar transducer assembly 10 with respect to the transceiving faces 34 is 29.0 mm. This diameter and the number of elements are greatly reduced as compared with a conventional scanning sonar.

By further stacking a plurality of layers (for example, 4 to 12 layers) of the helix element array of 13 elements, it is possible to realize a pitch similar to that of a conventional scanning sonar in both the circumferential direction CC and the longitudinal direction LG.

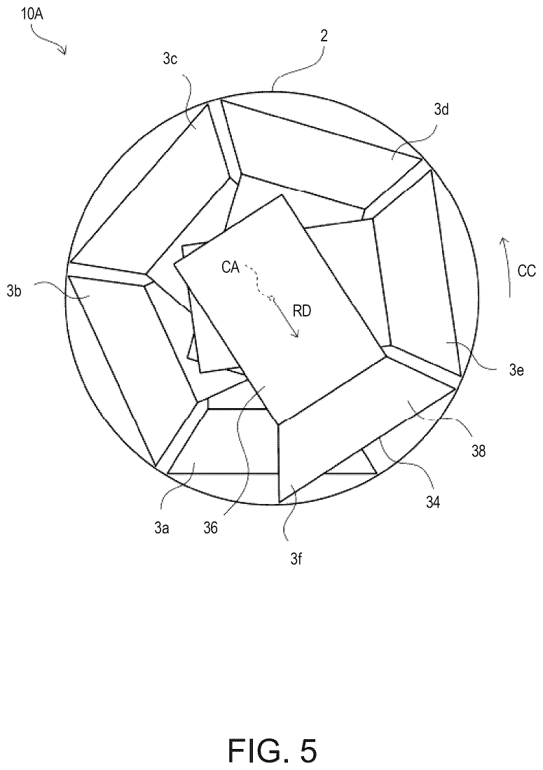

In the above-described embodiment, since the transducer element 3 is made thin, the intensity of transmitted ultrasound may be reduced. Therefore, as in modified sonar transducer assembly 10A shown in FIG. 5, the intensity of the ultrasound may be improved by providing a front mass 38 outside the transducer element 3 in the radial direction RD.

Specifically, the transducer element 3 in the modification has an element portion 36 formed of a piezoelectric element, and a front mass 38 coupled to the outside of the element portion 36 in the radial direction RD and gradually expanding toward the outside in the radial direction RD. The front mass 38 may be formed of metal, graphite, or the like.

This makes it possible to increase the area of the transceiving face 34 constituted by the front mass 38, so that the intensity of the transmitted ultrasound can be improved. The front mass 38 may extend not only in the circumferential direction CC but also in the longitudinal direction LG.

Although the embodiments of the present disclosure have been described above, the present disclosure is not limited to the embodiments described above, and various modifications are of course possible for those skilled in the art.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following.

What is claimed is:

1. A sonar transducer assembly comprising:
a housing having a cylindrical shape; and
a plurality of transducer elements arranged in the housing,
wherein the plurality of transducer elements is arranged in a longitudinal direction of the housing so that, at any position of the longitudinal direction, a number of the transducer elements is no more than one,
each of the plurality of transducer elements extends in a radial direction of the housing and comprises a transceiving face facing outward of the radial direction, and
extension directions of adjacent transducer elements of the plurality of transducer elements are different from each other.

2. The sonar transducer assembly of claim 1, wherein
the transceiving faces of the plurality of transducer elements are coupled to a side wall of the housing.

3. The sonar transducer assembly of claim 1, wherein
a length of each of the plurality of transducer elements in the radial direction is longer than a radius of the housing.

4. The sonar transducer assembly of claim 1, wherein
the plurality of transducer elements is arranged on a central axis of the housing.

5. The sonar transducer assembly of claim 1, wherein
the plurality of transducer elements is arranged so that the transceiving faces of the plurality of transducer elements are positioned on a helix curve.

6. The sonar transducer assembly of claim 5, wherein
the plurality of transducer elements is configured to transmit and/or receive ultrasonic wave having a given wavelength, and
a pitch of the helix curve is less than or equal to half of the wavelength.

7. The sonar transducer assembly of claim 5, wherein
two turns of the helix curve include N of the transceiving faces, N being an odd number, and
an angle formed by the extension directions of the adjacent transducer elements is 720/N degrees.

8. The sonar transducer assembly of claim 1, wherein
the plurality of transducer elements is configured to transmit and/or receive ultrasonic wave having a given wavelength, and
a pitch in the longitudinal direction between two closest transceiving faces of the transceiving faces of the plurality of transducer elements is less than or equal to half of the wavelength.

9. The sonar transducer assembly of claim 1, wherein
the plurality of transducer elements is configured to transmit and/or receive ultrasonic wave having a given wavelength, and
a pitch in a circumferential direction of the housing between two closest transceiving faces of the transceiving faces of the plurality of transducer elements is less than or equal to 0.4 times the wavelength.

10. The sonar transducer assembly of claim 1, wherein
each of the plurality of transducer elements comprises a front mass on outside of the radial direction.

11. The sonar transducer assembly of claim 1, wherein
the plurality of transducer elements is arranged so that the transceiving faces of the plurality of transducer elements are positioned on a helix curve;
the helix curve comprises at least two turns; and
a first transducer element, one or more second transducer elements, and a third transducer element of the plurality of transducer elements are arranged so that:
the one or more second transducer elements are arranged between the first transducer element and the third transducer element in the longitudinal direction,
the one or more second transducer elements comprise an even number of transducer elements,
the transceiving face of the third transducer element is positioned on the helix curve so as to be separated from the transceiving face of the first transducer element by two turns, and
the extension direction of the first transducer element is the same as the extension direction of the third transducer element.

12. The sonar transducer assembly of claim 1, wherein
the plurality of transducer elements is arranged so that the transceiving faces of the plurality of transducer elements are positioned on a helix curve;
the helix curve comprises at least two turns; and
a first transducer element, a second transducer element and a third transducer element of the plurality of transducer elements are arranged so that:
the second transducer element and the third transducer element are adjacent in the longitudinal direction,
the transceiving face of the second transducer element is positioned on the helix curve so as to be separated from the transceiving face of the first transducer element by less than one turn,
the transceiving face of the third transducer element is positioned on the helix curve so as to be separated from the transceiving face of the first transducer element by more than one turn, and
the extension direction of the first transducer element is in the middle between the extension directions of the second and third transducer elements.

13. A sonar comprising:
the sonar transducer assembly of claim 1; and
circuitry connected to the sonar transducer assembly.
